(19) United States
(12) Patent Application Publication
(10) Pub. No.: US 2022/0129668 A1
(43) Pub. Date: Apr. 28, 2022

(54) APPLAUSE GESTURE DETECTION FOR VIDEO CONFERENCES

(71) Applicant: Cisco Technology, Inc.,, San Jose, CA (US)

(72) Inventors: William Edward Reed, Tiburon, CA (US); Qian Yu, San Francisco, CA (US)

(21) Appl. No.: 17/080,947

(22) Filed: Oct. 27, 2020

(51) Int. Cl. G06K 9/00; H04N 7/15; H04N 5/445; G06F 3/16; G06K 9/62

(52) U.S. Cl. CPC G06K 9/00355; H04N 7/15; G06K 9/00718; G06F 3/16; G06K 9/6217; H04N 5/445

(57) ABSTRACT

In various embodiments, a device of a video conferencing system obtains a stream of video data depicting a participant of a video conference. The device analyzes the stream of video data to detect motion of the participant. The device identifies, by analyzing the motion of the participant using a machine learning model, the motion of the participant as clapping by the participant. The device provides the indication that the participant is clapping to one or more user interfaces of the video conferencing system.

### TECHNICAL FIELD

The present disclosure relates generally to computer networks, and, more particularly, to applause gesture detection for video conferences.

### BACKGROUND

Collaboration equipment, such as video conferencing equipment found in meeting rooms, kiosks, and the like are becoming increasing ubiquitous in many settings. For instance, meeting rooms in different geographic locations may be equipped with collaboration equipment that enable meeting attendees to video conference with one another. Other participants may be able to join the video conference by executing a corresponding application on their personal devices, such as computers, mobile phones, or the like.

Applause (clapping) is typically used to express approval during a speech or performance. However, this is often not practical during video conferences, particularly those that have a large number of participants. Notably, participants in larger video conferences are often on mute and cannot be heard. Even if they are not, audio mixing of large incoming streams of applause can lead to poor audio quality and participants being unable to hear one another.

### BRIEF DESCRIPTION OF THE DRAWINGS

FIGS. 1A-1B illustrate an example communication network;

FIG. 2 illustrates an example network device/node;

FIG. 3 illustrates various example components of a video conferencing system;

FIGS. 4A-4C illustrate an example of applause gesture detection during a video conference;

FIG. 5 illustrates an example architecture to detect an applause gesture during a video conference; and

FIG. 6 illustrates an example simplified procedure for detecting an applause gesture/clapping during a video conference.

### DESCRIPTION OF EXAMPLE EMBODIMENTS

### Overview

According to one or more embodiments of the disclosure, a device of a video conferencing system obtains a stream of video data depicting a participant of a video conference. The device analyzes the stream of video data to detect motion of the participant. The device identifies, by analyzing the motion of the participant using a machine learning model, the motion of the participant as clapping by the participant. The device provides the indication that the participant is clapping to one or more user interfaces of the video conferencing system.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

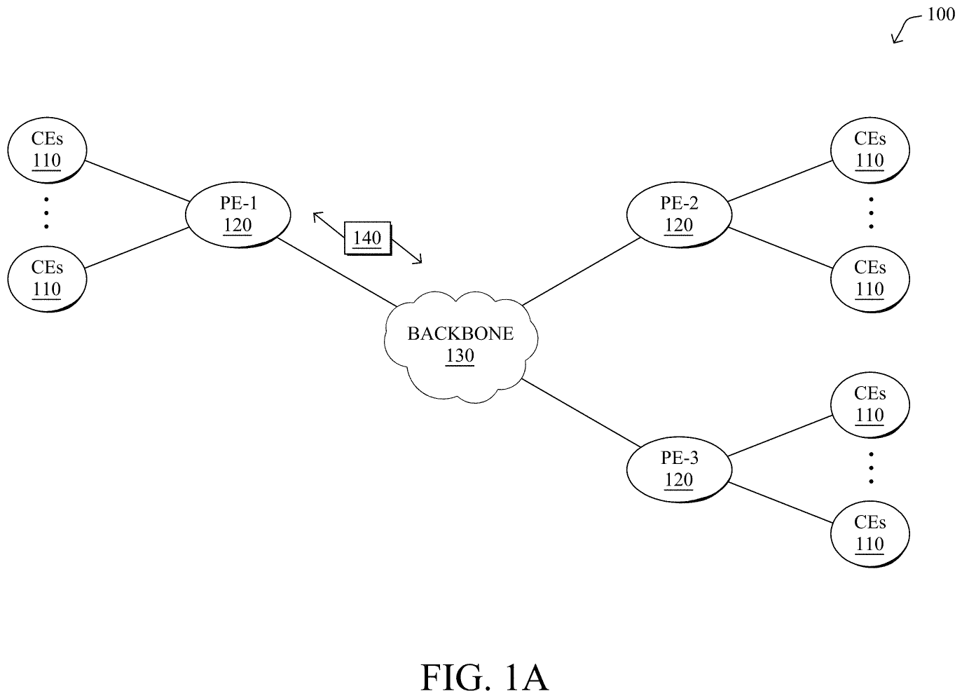

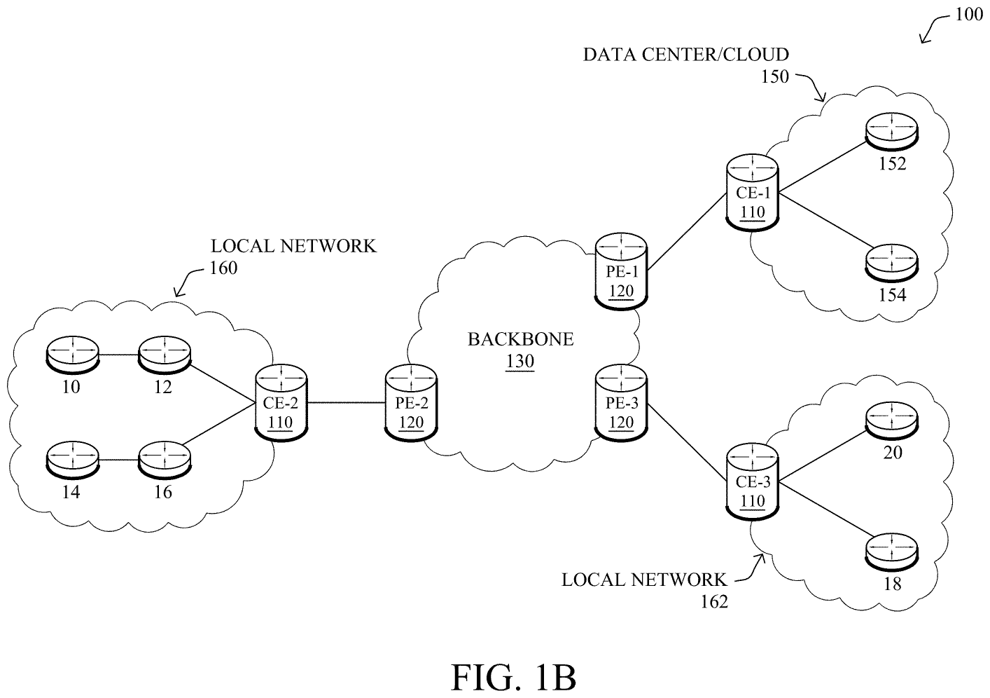

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, a server that provides a video conferencing/collaboration service (e.g., a management service), a server that provides a meeting scheduling service, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

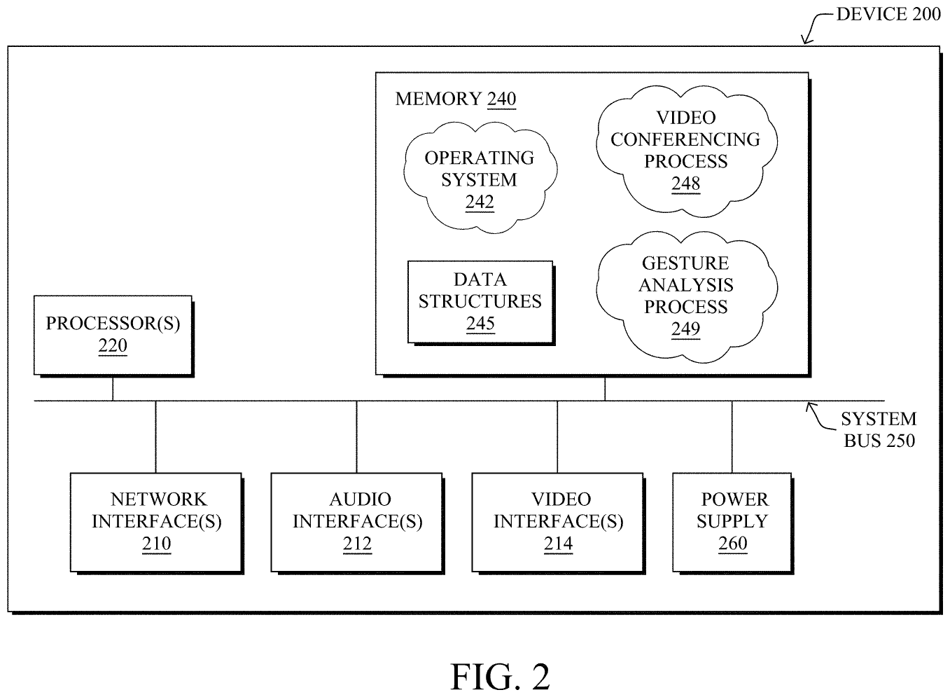

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below (e.g., a video conferencing/collaboration endpoint, a device that provides a management or booking service, etc.). The device 200 may also be any other suitable type of device depending upon the type of network architecture in place, such as IoT nodes, etc. Device 200 comprises one or more network interfaces 210, one or more audio interfaces 212, one or more video interfaces 214, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The audio interface(s) 212 may include the mechanical, electrical, and signaling circuitry for transmitting and/or receiving audio signals to and from the physical area in which device 200 is located. For instance, audio interface(s) 212 may include one or more speakers and associated circuitry to generate and transmit soundwaves. Similarly, audio interface(s) 212 may include one or more microphones and associated circuitry to capture and process soundwaves.

The video interface(s) 214 may include the mechanical, electrical, and signaling circuitry for displaying and/or capturing video signals. For instance, video interface(s) 214 may include one or more display screens. Preferably, at least one of the display screens is a touch screen, such as a resistive touchscreen, a capacitive touchscreen, an optical touchscreen, or other form of touchscreen display, to allow a user to interact with device 200. In addition, video interface(s) 214 may include one or more cameras, allowing device 200 to capture video of a user for transmission to a remote device via network interface(s) 210. Such cameras may be mechanically controlled, in some instances, to allow for repositioning of the camera, automatically.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a video conferencing process 248 and/or a gesture analysis process 249, as described herein, any of which may alternatively be located within individual network interfaces, the execution of which may cause device 200 to perform any or all of the functions described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

During execution, video conferencing process 248 may be configured to allow device 200 to participate in a video conference during which video data captured by video interface(s) 214 and, potentially, audio data captured by audio interface(s) 212 is exchanged with other participating devices of the video conference via network interface(s) 210. In addition, video conferencing process 248 may provide audio data and/or video data captured by other participating devices to a user via audio interface(s) 212 and/or video interface(s) 214, respectively. As would be appreciated, such an exchange of audio and/or video data may be facilitated by a video conferencing service (e.g., Webex by Cisco Systems, Inc., etc.) that may be hosted in a data center, the cloud, or the like.

In various embodiments, as described in greater detail below, gesture analysis process 249 may utilize machine learning techniques to detect certain gestures, such as applause/clapping, present in the video of a video conference. In general, machine learning is concerned with the design and the development of techniques that take as input empirical data and recognize complex patterns in the data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, gesture analysis process 249 may employ one or more supervised, unsupervised, or semi-supervised machine learning models. Generally, supervised learning entails the use of a training set of data, as noted above, that is used to train the model to apply labels to the input data. For example, the training data may include sample video data that depicts applause gestures and has been labeled as such.

On the other end of the spectrum are unsupervised techniques that do not require a training set of labels. Notably, while a supervised learning model may look for previously seen patterns that have been explicitly labeled, an unsupervised model may instead look to whether there are sudden changes in the behavior. Semi-supervised learning models take a middle ground approach that uses a greatly reduced set of labeled training data.

Example machine learning techniques that gesture analysis process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) models, artificial neural networks (ANNs) (e.g., for non-linear models), convolutional neural networks (CNNs), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly determined that a video conferencing participant made an applause/clapping gesture. Conversely, the false negatives of the model may refer to the number of times the model failed to identify when a video conferencing participant made an applause/clapping gesture. True negatives and positives may refer to the number of times the model correctly identified the lack of clapping by a participant, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

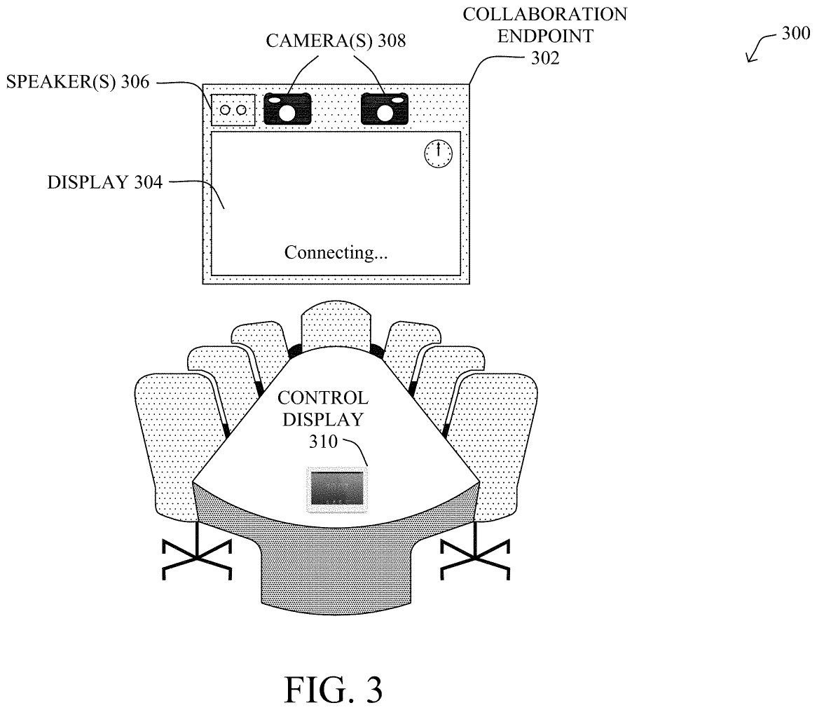

FIG. 3 illustrates an example meeting room 300 in which a collaboration endpoint 302 is located, according to various embodiments. During operation, collaboration endpoint 302 may capture video via its one or more cameras 308, audio via one or more microphones, and provide the captured audio and video to any number of remote locations (e.g., other collaboration endpoints) via a network. Such video conferencing may be achieved via a video conferencing/management service located in a particular data center or the cloud, which serves to broker connectivity between collaboration endpoint 302 and the other endpoints for a given meeting. For instance, the service may mix audio captured from different endpoints, video captured from different endpoints, etc., into a finalized set of audio and video data for presentation to the participants of a video conference. Accordingly, collaboration endpoint 302 may also include a display 304 and/or speakers 306, to present such data to any video conference participants located in meeting room 300.

Also as shown, a control display 310 may also be installed in meeting room 300 that allows a user to provide control commands for collaboration endpoint 302. For instance, control display 310 may be a touch screen display that allows a user to start a video conference, make configuration changes for the video conference or collaboration endpoint 302 (e.g., enabling or disabling a mute option, adjusting the volume, etc.

In some cases, any of the functionalities of collaboration endpoint 302, such as capturing audio and video for a video conference, communicating with a video conferencing service, presenting video conference data to a video conference participant, etc., may be performed by other devices, as well. For instance, a personal device such as a laptop computer, desktop computer, mobile phone, tablet, or the like, may be configured to function as an endpoint for a video conference (e.g., through execution of a video conferencing client application), in a manner similar to that of collaboration endpoint 302.

As noted above, applause (clapping) is typically used to express approval during a speech or performance. However, this is often not practical during video conferences, particularly those that have a large number of participants. Notably, participants in larger video conferences are often on mute and cannot be heard. For instance, during a video conference performed using collaboration endpoint 302, the conferencing service may exclude audio data captured by any microphones of collaboration endpoint 302 from being included in the audio that is transmitted to the other collaboration endpoints, if collaboration endpoint 302 has been muted during the video conference. This means that any clapping performed by participants located in meeting room 300 will be muted to those other participants not located in meeting room 300. Even if the applause is not muted, mixing the audio of many participants clapping can lead to poor audio quality and participants being unable to hear one another.

### Applause Gesture Detection for Video Conferences

The techniques herein allow for the automatic detection of applause gestures (i.e., clapping) by participants in a video conference, even when those participants are currently muted. In some aspects, an indication of any detected clapping may be provided to one or more user interfaces of the video conferencing system. For instance, the presenter of a video conference may be notified when one or more participants of the video conference are clapping.

Specifically, according to one or more embodiments of the disclosure as described in detail below, a device of a video conferencing system obtains a stream of video data depicting a participant of a video conference. The device analyzes the stream of video data to detect motion of the participant. The device identifies, by analyzing the motion of the participant using a machine learning model, the motion of the participant as clapping by the participant. The device provides the indication that the participant is clapping to one or more user interfaces of the video conferencing system.

Illustratively, the techniques described herein may be performed by hardware, software, and/or firmware, such as in accordance with gesture analysis process 249, which may include computer executable instructions executed by the processor 220 (or independent processor of interfaces 210) to perform functions relating to the techniques described herein, in conjunction with video conferencing process 248.

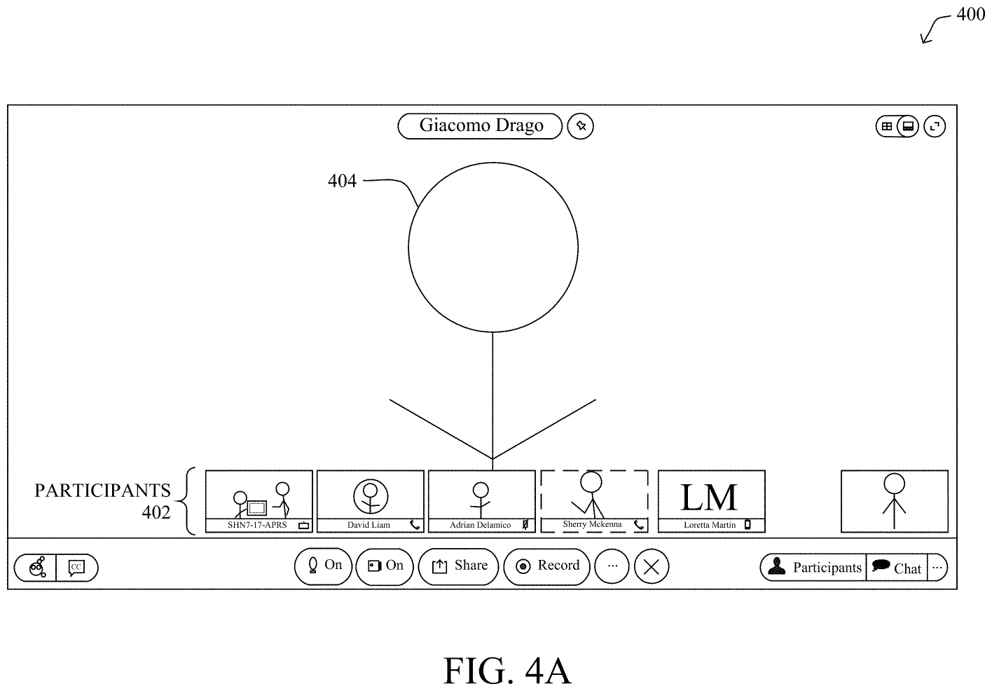

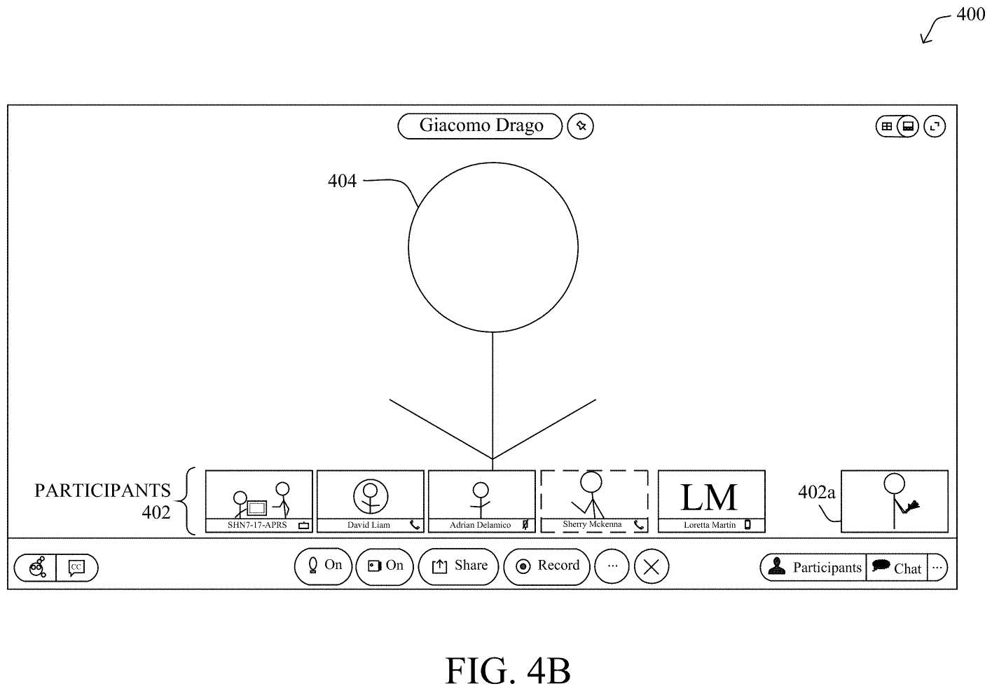

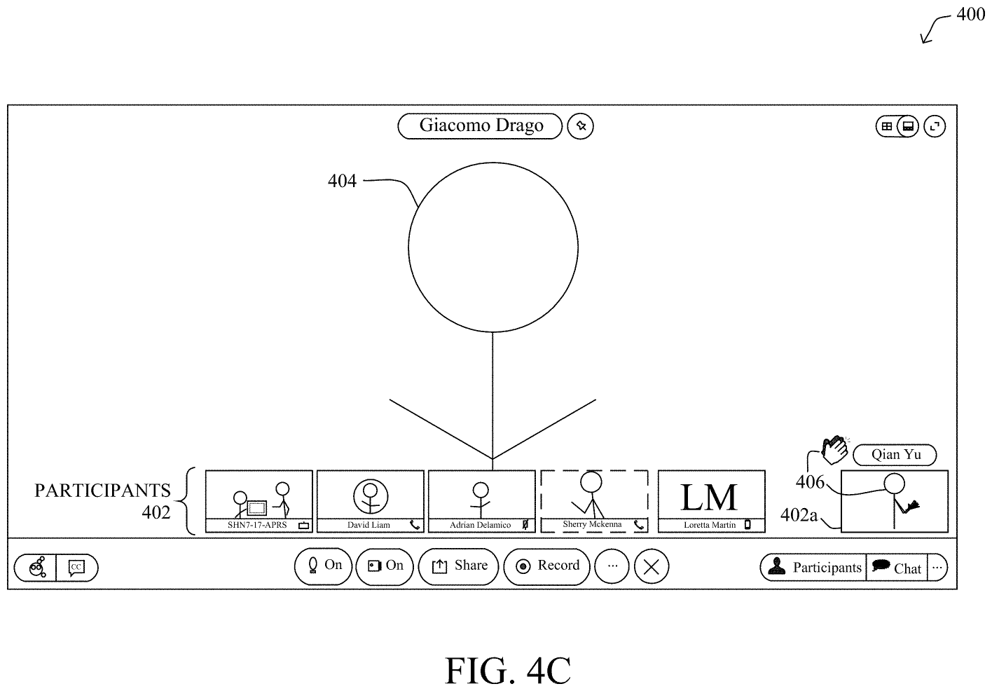

Operationally, FIGS. 4A-4C illustrate an example of applause gesture detection during a video conference, according to various embodiments. In particular, FIG. 4A illustrates an example display of a video conference 400 during which a plurality of participants 402 may conference with one another via audio and/or video. Because of the nature of virtual meetings, there is typically only one active speaker among participants 402. For instance, speaker 404 may be designated as the current presenter of the video conference and displayed prominently on screen.

In FIG. 4B, assume now that a particular participant 402, denoted ‘participant 402a,’ begins clapping during video conference 400 (e.g., in response to something that speaker 404 said). In some cases, a display of captured video data of participant 402a may be displayed as part of video conference 400. In other cases, however, participant 402a may not be displayed as part of video conference 400. This can be due, for instance, to participant 402a opting not sharing his video feed as part of video conference 400, parameters that control which participants 402 are displayed at any given time, or the like. Regardless, the clapping by participant 402a may either be:
1. Unmuted, resulting in the applause interrupting speaker 404, or
2. Muted, making the applause potentially being missed by speaker 404 and/or the other participants 402.

In FIG. 4C, the video conferencing system may automatically detect the clapping by participant 402a and, in turn, provide an indication of the detected clapping to one or more user interfaces that are part of the video conferencing system, according to various embodiments. For instance, in one embodiment shown, the indication of participant 402a clapping may take the form of a clapping icon that is presented to the display(s) showing video conference 400. Such indications may be provided in real-time (e.g., as the person is clapping), so as to provide feedback to the speaker/presenter, such as speaker 404.

In some embodiments, the applause gesture detection may be performed across any or all of participants 402 of video conference 400 and, in turn, the clapping indication may further indicate this. For instance, a separate clapping icon may be displayed in conjunction with the individual video feeds of the participants 402 that are clapping. In other cases, the indication may take the form of an aggregate indication. For instance, the indication may comprise a count of clapping participants 402 of video conference 400, a percentage of clapping participants 402, or the like.

In additional embodiments, the video conferencing system may provide an indication of one or more participants 402 clapping in the form of an audio track provided to one or more user interfaces of the system. For instance, even though participant 402a is muted, the video conferencing system may provide pre-recorded audio of applause to the speaker(s) of the endpoint operated by speaker 404. In some instances, the system may also vary the audio depending on factors such as the number or percentage of participants 402 clapping. For instance, the video conferencing system may play different recording of applause and/or vary the volume of the applause track, depending on the number or percentage of participants 402 that are clapping.

In further embodiments, the video conferencing system may prompt one or more participants 402 to clap as part of a gamification mechanism. For instance, the video conferencing system may prompt, via one or more of the user interfaces displaying video conference 400, one or more of participants 402 to begin clapping. This may be done, for instance, to poll the sentiment of participants 402 (e.g., to allow participants 402 to ‘vote’ via clapping, etc.). In another example, this may be done as part of a competition between participants 402 (e.g., to see which team is able to garner the most applause, to see which team can clap the most, etc.).

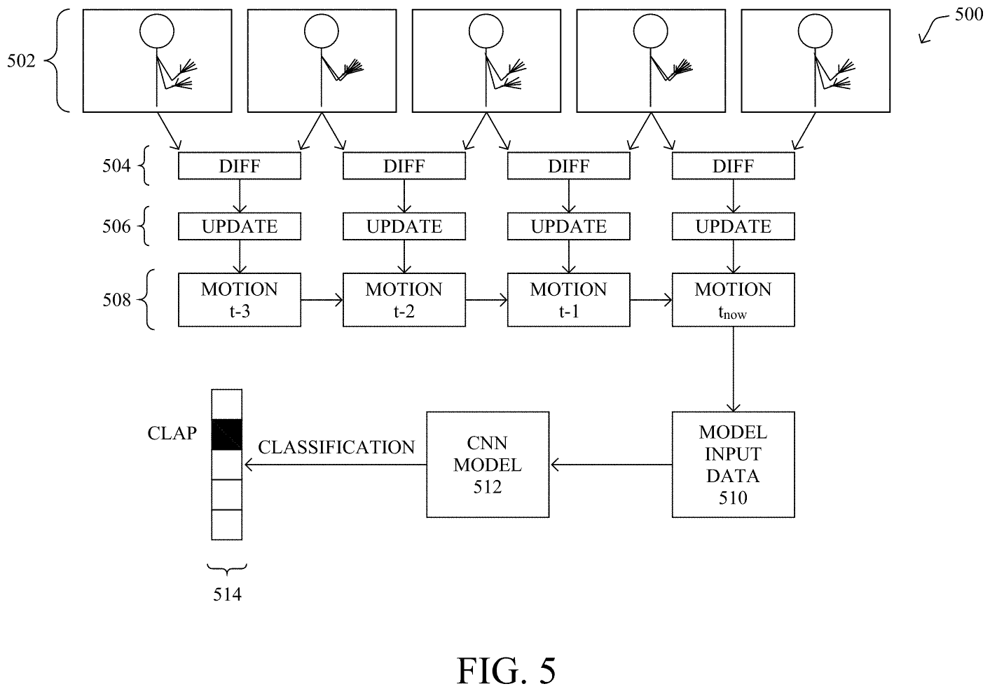

FIG. 5 illustrates an example architecture 500 to detect an applause gesture during a video conference, according to various embodiments. In general, architecture 500 may be used to implement gesture analysis process 249, which may be executed by a specifically configured device of a video conferencing system, such as an endpoint or a server that facilitates a video conference.

As shown, gesture analysis process 249 may obtain a video stream 502 of video data captured over time by a camera of an endpoint in the video conferencing system. As would be appreciated, stream 502 may comprise a series of still frame captures depicting a participant in a video conference over time. In various embodiments, gesture analysis process 249 may identify an applause gesture/clapping within video stream 502 by first detecting motion of the participant and then, in turn, classifying the motion as being clapping.

To identify clapping within video stream 502, gesture analysis process 249 may execute a machine learning classifier that has been trained to label certain motions as being clapping. For instance, as shown, architecture 500 may utilize a supervised learning model, such as convolutional neural network (CNN) model 512, that has been trained to apply an appropriate label to the various portions of stream 502 (e.g., ‘clapping’ or ‘not clapping’). Based on this label, the video conferencing system may provide an indication of the detected clapping to one or more user interfaces (e.g., a display, a speaker, etc.) of the system, as described previously.

In various embodiments, gesture analysis process 249 may generate model input data 510 for analysis by CNN model 512 by first computing the differences 504 in the frames of video stream 502 over time. Indeed, if the participant depicted in video stream 502 is moving, there will be some differences between the frames. For instance, pseudocode for this operation is as follows:

DIFF
/* Get color difference between frames by the subtracting
previous frame from the current one. /*
ABS([Frame T] − [Frame T-1] )

In turn, gesture analysis process 249 may perform an update operation 506 on its motion frame buffer using the computed difference frame for the current timestep. For instance, pseudocode for the update operation is as follows:

```
UPDATE
  // Update motion frame buffer in place with diff frame for current timestep
  MAX = 240, TIMESTEPS = 20, THRESHOLD = 20
  FOR DIFF pixel in DIFF_FRAME:
  IF DIFF pixel > THRESHOLD:
  MOTION pixel = MAX
  ELSE:
    MOTION pixel -= MAX / TIMESTEPS
```

As a result of the above computations, gesture analysis process 249 will have a history 508 of detected motion over time on which it may base model input data 510 for analysis and labeling by CNN model 512. As would be appreciated, by assessing not only the most recent frame and motion, but also a history of motion over time, CNN model 512 may discern between a true applause gesture and other motions similar to clapping. For instance, a participant may simply put her hands together and keep them folded for a period of time, which could otherwise be misinterpreted as clapping. However, by assessing the motion of the participant's hands towards each other, as well as away from each other, CNN model 512 can label the corresponding portions of video stream 502 as depicting clapping, appropriately.

For instance, by assessing the video data in video stream 502 shown, CNN model 512 may apply a clap label 514 to the corresponding frames of video stream 502. When performed in conjunction with the delivery of video stream 502 from its source endpoint to one or more other endpoints of the video conferencing system, this allows the system to provide indications of the identified applause gesture/clapping in conjunction with video stream 502 (e.g., in real-time during the video conference).

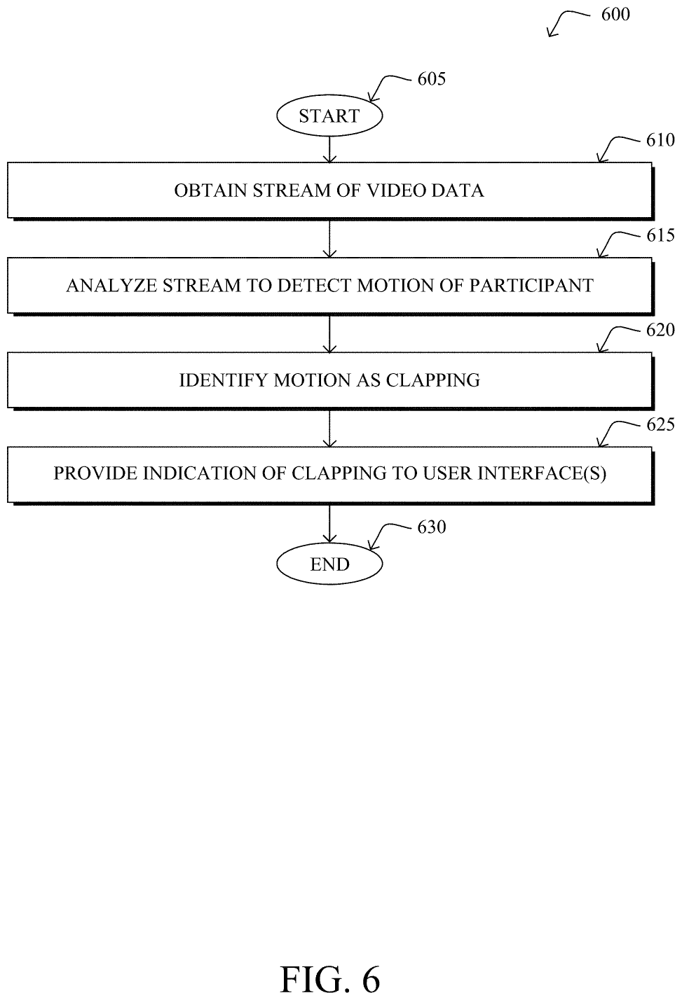

FIG. 6 illustrates an example simplified procedure 600 for detecting an applause gesture/clapping during a video conference, in accordance with one or more embodiments described herein. For example, a non-generic, specifically configured device (e.g., device 200) of a video conferencing system (e.g., a supervisory device, a collaboration endpoint, etc.) may perform procedure 600 by executing stored instructions (e.g., gesture analysis process 249 and/or video conferencing process 248). The procedure 600 may start at step 605, and continues to step 610, where, as described in greater detail above, the device may obtain a stream of video data depicting a participant of a video conference. For instance, if the device is a collaboration endpoint, it may obtain the stream of video data via one or more cameras. Alternatively, if the device is an intermediate device of the system (e.g., a server, etc.), it may obtain the stream of video data from a collaboration endpoint used by the participant.

At step 615, as detailed above, the device may analyze the stream of video data to detect motion of the participant. In some embodiments, the device may do so by computing differences between still captures (e.g., frames) from the stream of video data over time. Such differences may indicate, for instance, changes in the colors assigned to individual pixels or groups of pixels, or any other differences that can be detected with respect to the depiction of the participant.

At step 620, the device may identify, by analyzing the motion of the participant using a machine learning model, the motion of the participant as clapping by the participant, as described in greater detail above. In some embodiments, the device may do so using a supervised classifier, such as a convolutional neural network, to assign labels to the detected motion (e.g., ‘clapping’ vs. ‘not clapping,’ etc.). Training of such a model can be achieved by generating a sufficiently sized training dataset of labeled positive and negative examples, accordingly. In many instances, the device may base its identification solely on the video stream, such as when the participant is muted. However, further embodiments provide for the model to also take into account captured audio, as well.

At step 625, as detailed above, the device may provide an indication that the participant is clapping to one or more user interfaces of the video conferencing system. In some embodiments, the user interface(s) comprise at least one display and the indication comprises a count of clapping participants of the video conference. In another embodiment, the user interface(s) comprise at least one speaker and the indication take the form of pre-recorded audio of clapping. In such cases, the device may also vary the pre-recorded audio of clapping based on any number of factors, such as a count or percentage of participants that are clapping. In another embodiment, the device may provide the indication to at least a user interface associated with a designated presenter of the video conference (e.g., to give the presenter feedback). In addition, the indication may be provided to the user interface(s) in real-time while the video conference is occurring (e.g., while the participant is still clapping). Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce techniques that allow for the automatic detection of applause gestures made during a video conference, even if the participant that is clapping is currently muted. In turn, the video conferencing system may provide indicia regarding the applause to one or more user interfaces of the system, to notify other participants of the applause.

While there have been shown and described illustrative embodiments that provide for applause gesture detection for video conferences, it is to be understood that various other adaptations and modifications may be made within the spirit and scope of the embodiments herein. For instance, while the techniques herein are described primarily with respect to an enclosed meeting room, such as a conference room, the techniques herein are equally applicable to other locations, as well, such as auditoriums, outdoor locations, and the like. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device of a video conferencing system, a stream of video data depicting a participant of a video conference;
analyzing, by the device, the stream of video data to detect motion of the participant;
identifying, by the device analyzing the motion of the participant using a machine learning model, the motion of the participant as clapping by the participant; and
providing, by the device, an indication that the participant is clapping to one or more user interfaces of the video conferencing system.

2. The method as in claim 1, wherein the participant is muted in the video conference when the participant is clapping.

3. The method as in claim 1, wherein the one or more user interfaces comprise at least one display, and wherein the indication comprises a count of clapping participants of the video conference.

4. The method as in claim 1, wherein the one or more user interfaces comprise at least one speaker, and wherein the indication comprises pre-recorded audio of clapping.

5. The method as in claim 4, further comprising:
varying the pre-recorded audio of clapping based on a count of clapping participants of the video conference.

6. The method as in claim 1, wherein analyzing the stream of video data to detect motion of the participant comprises:
computing differences between still captures from the stream of video data over time.

7. The method as in claim 1, wherein identifying the motion of the participant as clapping by the participant comprises:
using a convolutional neural network to label the motion as clapping.

8. The method as in claim 1, further comprising:
providing, by the device and via at least one of the one or more user interfaces, a request for the participant to begin clapping.

9. The method as in claim 1, wherein at least one of the one or more user interfaces is associated with a designated presenter of the video conference.

10. The method as in claim 1, wherein device provides the indication that the participant is clapping to one or more user interfaces of the video conferencing system in real-time while the video conference is occurring.

11. An apparatus, comprising:
one or more network interfaces;
a processor coupled to the one or more network interfaces and configured to execute one or more processes; and
a memory configured to store a process that is executable by the processor, the process when executed configured to:
obtain a stream of video data depicting a participant of a video conference;
analyze the stream of video data to detect motion of the participant;
identify, by analyzing the motion of the participant using a machine learning model, the motion of the participant as clapping by the participant; and
provide an indication that the participant is clapping to one or more user interfaces of a video conferencing system.

12. apparatus as in claim 11, wherein the participant is muted in the video conference when the participant is clapping.

13. apparatus as in claim 11, wherein the one or more user interfaces comprise at least one display, and wherein the indication comprises a count of clapping participants of the video conference.

14. apparatus as in claim 11, wherein the one or more user interfaces comprise at least one speaker, and wherein the indication comprises pre-recorded audio of clapping.

15. The apparatus as in claim 14, wherein the process when executed is further configured to:
vary the pre-recorded audio of clapping based on a count of clapping participants of the video conference.

16. apparatus as in claim 11, wherein the apparatus analyzes the stream of video data to detect motion of the participant by:
computing differences between still captures from the stream of video data over time.

17. The apparatus as in claim 11, wherein the apparatus identifies the motion of the participant as clapping by the participant by:
using a convolutional neural network to label the motion as clapping.

18. The apparatus as in claim 11, wherein the process when executed is further configured to:
provide, via at least one of the one or more user interfaces, a request for the participant to begin clapping.

19. The apparatus as in claim 11, wherein at least one of the one or more user interfaces is associated with a designated presenter of the video conference.

20. A computer-readable medium that is tangible, non-transitory, and stores program instructions that cause a device of a video conferencing system to execute a process comprising:
obtaining, by a device of a video conferencing system, a stream of video data depicting a participant of a video conference;
analyzing, by the device, the stream of video data to detect motion of the participant;
identifying, by the device analyzing the motion of the participant using a machine learning model, the motion of the participant as clapping by the participant; and
providing, by the device, an indication that the participant is clapping to one or more user interfaces of the video conferencing system.
